(19) United States
(12) Patent Application Publication
(10) Pub. No.: US 2008/0228625 A1
(43) Pub. Date: Sep. 18, 2008

(54) PARTNER RELATIONSHIP MANAGEMENT SYSTEM

(76) Inventors: Stephen T. Isaf, Marietta, GA (US); David A. Knowles, Decatur, GA (US); William Green, Marietta, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/952,184

(22) Filed: Dec. 7, 2007

Related U.S. Application Data
(63) Continuation of application No. 09/893,291, filed on Jun. 27, 2001, now abandoned.
(60) Provisional application No. 60/214,615, filed on Jun. 28, 2000.

(51) Int. Cl. G06Q 40/00

(52) U.S. Cl. 705/37

(57) ABSTRACT

A Partner Relationship Management System (“PRMS”) accessible for sellers and buyers located remotely, whereby the buyers' access privileges are based on their relationship with the sellers. The PRMS comprising a server connected to the Internet and a pricing configurator which includes at least, a buyer profile module residing on the server and storing information on a plurality of buyers, logistics data and a price converter. The information on each buyer includes at least a delivery destination, and a pricing factor. The pricing factor is unique to each buyer. The pricing configurator converts an origin offer price, such as a free-on-board price, to a delivered price, such as a cost-insurance-freight price by considering the information of the buyer profiles and the logistics data.

### CROSS-REFERENCE

This application is a continuation of U.S. patent application Ser. No. 09/893,291, filed Jun. 27, 2001; which application claims the benefit of U.S. Provisional Patent Application Ser. No. 60/214,615, filed Jun. 28, 2000.

The specification and drawings of U.S. patent application Ser. Nos. 09/893,291 and 60/214,615 are hereby incorporated, in their entirety, by this reference.

### FIELD OF THE INVENTION

This invention is related to distributed computer systems. More specifically, it is related to systems and methods for a web or global network based business tool.

### BACKGROUND OF THE INVENTION

The worldwide trade in meat and poultry products is conservatively estimated to be a $44 billion market representing approximately 24 million metric tons of worldwide cross border transactions each year. At a 5% growth rate, the industry could grow to be a $56 billion market by the year 2005, representing approximately 30 million metric tons of transactions. The industry's highly fragmented trading process has spawned a varied network of primary, secondary, and tertiary buyers and sellers that range from some of the world's largest and most diversified corporations to extremely small importers and sellers specializing in distributing a single product within one country.

The international distribution of these commodities has grown rapidly in recent years aided by the reduction in worldwide trade barriers, rising global per capita income levels, and improvements in international communication and transportation. The Uruguay Round of Agreement Act, part of the General Agreement on Tariffs and Trade, (GATT), the subsequent formation of the WTO, the North American Free Trade Agreement, the opening of the former Soviet Union, the continued integration of the European Union, and recent trade agreements with China have all served as catalysts for the international trade in meat and poultry products.

In developing countries, economic growth has allowed consumers to diversify their diets to include more value-added proteins; further fueling increased international trade and extending access to more consumers worldwide. Improvements in the international distribution chain by ancillary service providers such as shipping companies, insurers, banks, and cold storage firms have allowed more sellers and buyers to interact more efficiently. Finally, a growing awareness of the importance of the international marketplace on the part of meat and poultry sellers has led to the development of numerous export specific products with unique pricing, specification, packaging, and marketing elements completely independent of once-dominant domestic markets.

Participants in this market are varied and diverse, with each type of supplier and buyer bringing a certain degree of value to the transaction. In general, sellers of food products are comprised of the international and domestic departments of large food producers, trading companies, and brokers/agents. Overseas buyers are typically classified as food manufacturers, retailers, food service distributors, and importer/wholesalers. This competitive marketplace, however, has continually demanded that all participants provide greater value-added services in the way of financial liquidity, market information, just in time delivery, logistics, documentation, product specification, risk management, and pricing advice.

Other key participants in the complex distribution chain are trucking companies, railroads, ocean carriers, private and government inspection services, cold storage companies, international banks, and international cargo and credit insurance companies. Ocean carriers and railroads have made the most substantial Internet technology investments to date, although their focus has been primarily in the area of equipment tracking and tracing. As a whole, however, the international meat and poultry industry has lagged far behind other industries of comparable size in applying Internet technology to support complex transactions.

The United States is the world's leading meat and poultry exporter with an estimated $6.3 billion in exports. The large size of the market, in conjunction with the tremendous inefficiencies that presently exist in the trading process and the emergence of Internet technology, presents a unique opportunity for establishing an international trading application that will automate and streamline trading processes and drive efficiencies into the entire industry.

Currently this market is not served in a meaningful way by Internet-based “sell-side” technologies, and there are no applications available to specifically support the needs and unique nature of the international trading process. The current lack of a standardized and centralized trading platform creates a barrier to the efficient conduct of the international trade of meat and poultry. Additionally, no centralized source of international market information currently exists. Internet bulletin boards and food exchanges do not support the current conventions used to transact business and negotiate prices, nor do they address the highly specialized needs of the international marketplace.

Given the absence of a unified and standardized trading platform, the international trade of meat and poultry products is presently conducted using a variety of manually intensive methods that are heavily dependent on telephone and fax technology. In a typical transaction, buyers and sellers must communicate numerous times by phone, fax, or email to negotiate the complex terms of a sale. The absence of meaningful automated tools has made the simple act of international price dissemination extremely labor-intensive, monopolizing the time and efforts of highly specialized employees. Some of the industry's unique characteristics, listed below, demonstrate the inefficiencies and opportunities for improvement within the marketplace.
A reliance on phone, fax, and email communication for nearly all negotiations and market information dissemination
An industry that is extremely efficient in price determination, but extremely inefficient in service delivery and information dissemination
A production system that drives the entire sales process, and often predetermines seller profitability
A cash-intensive industry that has historically had the tightest credit terms of any major economic sector
A market that is perpetually seeking financial and inventory liquidity
An industry in which the significant international buyers and sellers are generally well known to all participants in the market
An industry in which the establishment, development, and enhancement of personal trading relationships between individuals is of paramount importance
An industry in which knowledge of international logistics, government regulations, and financial processes are critical to market competitiveness

The current value chain in the meat and poultry industry is an exchange of product, revenue, market price information, financial liquidity, risk abatement, international market expertise, and specialized shipping services among traders, distributors, producers, logistic providers, processors, insurance providers, and retailers typically through inefficient and fragmented channels.

The current operating processes in the meat and poultry industry present an opportunity to develop a network for processing international trading transactions in an effective and efficient manner. The infrastructure to process these transactions electronically does not exist today due to the lack of appropriate, targeted information technology (IT) investment. The meat and poultry industry has traditionally lagged behind other sectors in the adoption of new sales oriented technologies, as the majority of IT investment has been directed toward improving production processes or developing sophisticated inventory control systems. Consequently, sales processes provide an excellent opportunity for process automation and enabling technologies.

International trading is currently handled without web-enabled systems or an efficient process for gathering and communicating market information. The industry has yet to develop a toolset that leverages technology to automate manual sales processes, centralize market information, and increase market efficiency.

### SUMMARY OF THE INVENTION

Briefly described, the present invention comprises a partner relationship management system (“PRMS”), and includes a platform structure and operational and interrelational methods specifically designed to facilitate direct and personal contact between trading partners, as, for example, in the international food industry. The PRMS, in its preferred embodiments, comprises at least a product catalog and a price configurator accessed via a global computer network or other communication network. In at least one embodiment, the price configurator is comprised of at least a buyer profile, a logistics rate table, and a price converter.

In at least one embodiment, (i) a seller utilizes the system to enter and maintain a product catalog, a plurality of buyer profiles (each representing one of a plurality of buyers), and a logistics rates table (some information of which is acceptably provided by a system administrator/service provider), and (ii) the PRMS uses the entered information, on behalf of the seller, to convert a product offer entered one time by the seller into a plurality of unique offers each uniquely targeted to one of the plurality of buyers and to communicate each of the unique offers to the proper, respective buyer. The system then provides for a controlled and, in certain embodiments, documented exchange of offers and counteroffers to, hopefully, result in a completed transaction.

The partner relationship management system provides, in at least one exemplary embodiment, for a plurality of sellers to confidentially make simultaneous use of the system, maintaining separate seller environments each involving at least a customized and confidential product catalog, customized to the respective seller, a plurality of buyer profiles confidentially introduced and maintained by separate sellers, and logistics rate tables including a logistics component confidentially maintained by each individual seller. According to one embodiment of this plural seller embodiment, the system supplies common components, such as but not limited to certain logistics data and converter programs and algorithms, commonly maintained by a “superuser” or system administrator/service provider and made available to all system seller environments. In alternate embodiments, buyers whose profiles are introduced to the system by one or more sellers can confidentially interface, within the parameters of the system, with any and all sellers who have introduced them to the system.

In exemplary embodiments, the product catalog and price configurator are each accessed and functioning within a hierarchical permission system defining user (seller and buyer) interfaces. In accordance with at least one exemplary embodiment of the present invention, the PRMS is designed upon a hierarchical permission framework that identifies specific functional users within a food producing or other selling organization and allows those users to see and do only what their organization predetermines through a configuration process. This provides selling organizations with better control over currently decentralized and fragmented work processes, and enables functional users of the system to work within an application that has a user interface (see “personalized interface” below) designed with their specific job function in mind. The purposes of the PRMS include at least: 1) to provide organizations involved in selling dynamically priced goods (i.e., goods whose price fluctuates frequently) with an internal tool for managing product, price, and position information within their organization among various functional users; 2) to provide these organizations with a scalable tool for privately communicating with their customers and managing highly personal relationships that are characteristic of industries involved with the international trade of dynamically priced goods; and 3) to bring scalability to a previously non-scalable work process.

This invention provides worldwide sellers and customers (for example, worldwide food sellers and buyers) a seamless and integrated trade solution via a platform specifically designed to meet the demands and requirements of the international marketplace. A value provided by the partner relationship management system is its method of facilitating direct and personal contact between sellers and their customers, allowing system participants to maintain and enhance their confidential relationships with their customers around the world. The PRMS is designed to allow for the maximum possible degree of personalization for both sellers and customers (including, but not limited to, overseas customers), which has been recognized as a crucial element in every international transaction. Sellers will submit their specific and unique buyer profiles into the system equipped with the present invention with the assurance that this information will remain completely confidential. Sellers will also be able to enter and maintain their logistics and product specifications in the system on a secure and confidential basis.

Buyer profiles supplied by the sellers will contain detailed information about a buyer, including but not limited to some or all of: contact information for the buyer's manager and/or his alternate contact, contact's e-mail address, the company name and account status, shipping terms, acceptable weights, products purchased, delivery destinations, sales terms, average days of outstanding invoices, credit terms, credit notes and credit limit and a Unique Pricing Factor, or “UPF”. The UPF may reflect a special discount (or increase) rate or other special pricing attribute for a particular buyer, and usually reflects the special relationship between a particular buyer and seller.

Buyers are invited to use the PRMS only through their relationships with sellers. After a seller enters its buyer profiles, the buyers who have been profiled, e.g. identified as “business partners” by a seller, will receive a notification that access privileges to the PRMS have been granted. In certain embodiments, once a buyer is first profiled by a seller, that buyer is automatically notified by, and a password is automatically generated by the PRMS. In other embodiments, after a buyer is profiled by a seller, a platform administrator (e.g. platform superuser) must approve the buyer, set up passwords, and notify the buyer of his access privileges.

Sellers can then transact with buyers through the PRMS. When a seller has a load of product for sale, he can simply enter the product information, the desired Free-on-Board (FOB) price or any other recognized shipping term into the PRMS. The PRMS automatically generates a proper and customized delivered price for each of the buyers that have been previously profiled by the seller to receive the particular product (sometimes referred to as the “targeted buyer's”). For example, a Cost Insurance Freight (CIF), Cost and Freight (CNF) or other recognized delivered price is generated depending on the shipping term the seller chooses in the particular buyer's profile. Thus, and then, a customized delivered price is presented to those respective buyers. The offers are made available for the targeted buyers, and the targeted buyers will receive a notification about the availability of the offers. In certain embodiments, the offers are posted in the PRMS system and the targeted buyer will access the PRMS to view the offers. In other embodiments, the system forwards the offers to the buyer via, for example, e-mail.

Conversely, when a buyer needs to purchase a batch of a product, he can enter the product specification and the desired delivered price (i.e. his “bid”) that he is willing to pay. The desired delivered price or “bid” will be processed through the system's price configurator in reverse and presented to a pricing manager as an origin price, reflecting a shipping term (e.g., in FOB [Seller's Town]) which the seller has pre-selected (e.g. at setup).

By way of example only, two elements—buyer profiles and logistics rate tables (including freight costs) will form a basis of the price configurator to effect an automatic pricing system that converts a seller's offer price, e.g., FOB (Free On Board) [Location #1] price, to individual delivered prices, e.g. CIF [Port Z] prices, and vice versa, based on customer profiles, shipment and delivery locations. For example, if a seller enters a price on pork loins at $1.10/lb FOB Des Moines, the system will first search all buyers in the seller's buyer profiles, to determine which are profiled for pork loins. The system will then look to where the buyers are located, e.g. Kobe, Taiwan and Hong Kong. The system will then automatically offer the targeted buyers, at a customized price for each targeted buyer, the opportunity to purchase at, for example, $1.22/lb CIF Kobe, $1.25/lb CIF Taiwan, and $1.30/lb CIF Hong Kong, accounting for varying freight rates and market variations. Rates for the various buyer destinations are stored in logistics rate tables.

After reviewing these offers, the buyers can then accept the offers or further negotiate with the sellers through the PRMS. Any counteroffer information stays in the system and the sellers are notified of the counteroffers through e-mails or other communication means. The information about offers and counteroffers are sensitive trade information and are stored in the system. The existence of any trading relationship between a particular seller and its buyers is not shared or accessible by any other system users. This privacy is maintained and secured by the system model.

Through the use of the PRMS and its pricing configurator, the international departments of sellers will be able to focus their efforts on activities that drive value and profits into their organizations, such as relationship building, new product development, and branding. In exemplary embodiments, a permissioning system in accordance with the present invention allows parties within an organization, as well as parties between organizations, to give and receive data in such a way as to enable information flow and to make transactions more efficient. This system allows sellers to achieve flexibility and to make visible real-time transactions within an organization between the various responsible managers, such as pricing, product and relationship managers.

Consequently, the permissioning system of the present invention allows production and logistics personnel to be advised of company transactions in real-time based on permissioning access to these personnel within the company. The seller can choose to have the system notify certain divisions or personnel upon a particular occurrence within the system.

Additional functionality of the PRMS include:
A real-time interactive trading platform allowing overseas customers to instantly purchase offers made on a firm basis
Real-time worldwide market reports based on transactions and reported information from participants
Updated shipment tracing and position reporting information
Consolidated shipment reports segmented by customer and market
Seamless flow of information to internal logistics and finance personnel
Online document access and retrieval
Ability for sellers to conduct project auctions designed in accordance with sellers specific needs and sales objectives, such as the sale of special items, quantities, timeframes, or buyer groups.

Numerous features, objects, and advantages of the present invention in addition to those mentioned or implied above will become apparent upon reading and understanding this specification, read in conjunction with the appended drawings.

### DESCRIPTION OF THE DRAWINGS

The invention is better understood by reading the following detailed description of the preferred embodiment in conjunction with the accompanying drawings, wherein:

FIG. 1 is an illustration of a partner relationship management system of the present invention, in accordance with one embodiment thereof.

FIG. 2 is an illustration of a partner relationship management system, in accordance with an alternate embodiment thereof.

FIG. 3 is an illustration of a permission tree related to one acceptable embodiment of a hierarchical permissioning system used by the PRMS of the present invention.

FIGS. 4A-4C are examples of personalized interfaces for a relationship manager, pricing manager, and buyer, respectively, for an exemplary embodiment of the PRMS.

FIG. 5 is an illustration of one embodiment of a partner relationship management system, of the present invention, assisting a seller to simultaneously offer his product to a plurality of buyers.

FIG. 6 is an illustration of one embodiment of a partner relationship management system of the present invention, assisting a buyer to simultaneously place an offer to buy to a plurality of sellers.

FIG. 7 is an illustration of a partner relationship management system architecture in accordance with one embodiment of the present invention.

FIG. 8 is a flow chart of an account management process engaged in with a seller, in accordance with one embodiment of the present invention.

FIG. 9 is a flow chart of a general product offering process engaged in with a seller, in accordance with one embodiment of the present invention.

FIG. 10 is a flow chart of an offer responding process engaged in with a buyer, in accordance with one embodiment of the present invention.

FIG. 11 is a flow chart of a counteroffer responding process engaged in with a seller, in accordance with one embodiment of the present invention.

FIG. 12-16 are representative screen shots of selected configuration screens illustrating certain configuration steps in accordance with one limited example of an embodiment of the present invention.

### DETAILED DESCRIPTION OF SELECTED EMBODIMENTS

Although the following description is based on international trade of meat and poultry, it is understood that the present invention is equally applicable in domestic trades and in other commodities and markets.

For a better understanding of the herein-mentioned components and their functions, as well as a better understanding of the terms used herein, the following summaries are presented. Note that certain components discussed below (and throughout this specification) are in the exemplary form of modules, although the invention is not to be restricted to any particular software form or structure. Furthermore, these summaries and the information mentioned therein are intended to form a basis for understanding of exemplary embodiments of the present invention, and the invention is not restricted thereto.

### Some System Components and Related Functions:

Logistics Rate Tables Module—A seller maintained database (with associated database management programs) of logistics information and rates. In some embodiments, the logistics rate tables module comprises all of the logistics information and rates available to a specific seller environment. In other embodiments, the logistics rate tables module is a seller-specific component of the PRMS that is a subset of a larger database which includes, for example, but not limited to, system maintained common databases of logistics information and rates. As rate information is proprietary to users of the system, and it is essential to calculating prices on a “delivered” basis, the PRMS allows for selling organizations to store and manage logistics rates within the system from their desired points of origin to their desired points of destination. Certain users of the system can edit rate values, origin locations, and destination locations, and once executed these changes are immediately reflected in the organizations' product offers that are conducted through the PRMS.

Buyer Profiles Module—Component (including database(s) and associated management programs) of PRMS that stores and manages buyer-specific information such as product, offer, and pricing preferences. The international trade of dynamically priced goods is highly personal and private in nature, and the buyer profiles within PRMS are designed to maintain these transaction characteristics while allowing for increased customer reach and more frequent and timely personal contact between trading partners. In addition to general corporate information about a buyer (name, address, contacts, bank information, etc.), the buyer profiles will be linked to the product catalog module of the PRMS, allowing specific products of the selling organization to be added to the list of products to automatically offer a particular buyer. In addition, a Unique Pricing Factor (or UPF), calculated in either percentage terms or in currency-per-unit terms, is an important element of the buyer profile. The UPF allows selling organizations to price customers uniquely and individually, and in conjunction with the logistics rate tables form an essential component of the PRMS price configurator.

Product Catalog Module—Module (database(s) and associated management programs) within PRMS in which selling organizations are able to enter and maintain their own private catalog of products. The catalog within PRMS allows for both general and custom attributes of products, and “product managers” (defined below) are able to add, edit, or delete entire products or individual product attributes within the system.

Converter—A software program or program function which operates to apply an algorithm. In accordance with preferred embodiments of the present invention, the algorithm applied by the converter combines an input price component, a logistics component, and a subjective component to generate an output price. In at least one preferred embodiment, the algorithm is adjusted to generate an output price stated as price per unit of weight. The converter, in alternate embodiments, makes appropriate adjustment to present the output price for weight in pounds, kilograms or metric tons (or per pound, per kilogram, or per metric ton). The input price component reflects either the origin price or delivered price (depending upon if its input by the seller, for example, by the seller's pricing manger, or the buyer) for a selected product. The logistics component is, for example, presented as a logistics value which equals the total cost (or per unit of weight cost) for moving the selected product from Location A to Location B. The subjective component is primarily comprised of the UPF assigned, subjectively (though perhaps logically), to the respective buyer by the seller.

By way of example only, the following are algorithms acceptably utilized by the converter of one embodiment of the present invention:

{[(origin price×weight)+logistics value]/weight}±UPF (as a currency value)=delivered price

{[(origin price×weight)+logistics value]/weight}×UPF (as a percentage value)=delivered price

Price Configurator—A system feature which combines data of the Buyer Profiles module and Logistics Rate tables module and acts on the data with algorithms applied by the converter, by which prices input to the PRMS are configured to prices for output from the PRMS. PRMS has been designed to configure delivered prices of products, and to target these offerings in such a way as to reflect individual selling and buying preferences. The price configurator combines relationship and mathematics as a result of an algorithm interacting with the buyer-specific profiles module and seller-specific logistics rate tables module in order to present targeted offers to buyers via the Internet or other network.

### Glossary of Users

First level functional user positions of a “seller”. In some of its embodiments, the PRMS anticipates sellers with one employee performing many functions (and, thus, engaging in many or all of the functional user positions” mentioned) as well as sellers with many employees, each engaging in only one of the functional user positions, and staffing situations in between. It is to be understood that each functional position might be occupied by a different individual or that one individual might occupy a plurality of these functional user positions. The distribution of functional user positions among multiple employees or representatives of the seller, though not required in acceptable embodiments of the present invention, does provide for a fuller utilization of the hierarchical permission framework of the present invention.

Product Manager—System user responsible for creating and maintaining a company's product catalog.

Pricing managers—Generic term for a system user responsible for determining an organization's position on a particular lot of goods. Position determination is comprised of, for example, some or all of the following elements: product, quantity available, shipment period, location of product, and price. “Pricing manager” is analogous to the following terms used within the food industry today: “commodity manager,” “product manager” (i.e., “Further Process Products Manager”), “domestic sales manager,” etc.

Relationship manager—System user who has primary responsibility for customer-facing activities: negotiating with customers on price, handling service issues, building client relationships, etc. Within the food industry today, this position is often called a “sales manager,” “account manager,” “export manager,” or “regional manager.”

Logistics managers—System user responsible for entering and maintaining key elements of the logistics rate tables such as product origins, customer destinations, and rate values. In today's industry, this person is often referred to as a “traffic manager.”

Corporate Admin Super User: User at the top of a selling organizations' permission tree responsible for the creation of all other corporate users.

Functional Super Users: System users who have been granted the authority through the permissioning system to create users under themselves and to view and perform all of the functions of their subordinates. PRMS allows for functional super users in all of the above-mentioned areas.

### System Wide User:

Platform Super User(s)—Employees of the platform administrator/service provider that have access to all system functionality, and reside at the top level of the hierarchical permission tree. In order to support the system and provide help services to users, Platform Super Users are able to perform all functions of the system and can perform actions on behalf of all users below them on the hierarchical permission tree.

### Glossary of Terms

FOB [location]: Free On Board at the named location; CIF [location]: Cost Insurance Freight at the named location—two of a plurality of shipping terms which reflect internationally accepted terms defining relative obligations and rights of sellers and buyers. By way of example, reference is hereby made to “Incoterms” (developed by the International Chamber of Commerce). While further explanation is not deemed necessary for those skilled in the art, additional information is found currently at: http://www.iccwbo.org/incoterms/faq.asp. PRMS accepts input of prices which cite Incoterms, and is able to calculate and convert such prices, through the PRMS price configurator, to corresponding prices reflecting different “incoterms”. PRMS calculates prices from the location of origin to the location of delivery through the use of its price configurator. Throughout this specification, a short form of shipping term, such as FOB or CIF (absent the [location] label is used for ease of presentation; however, it should be understood that the short form is meant to be synonymous with the respective term including the [location] label.

Personalized Interface: That graphical user interface presented to a particular user as defined by and which defines the particular user's interaction with the trading platform 11 as a result of the particular user's privileges under the hierarchical permissioning system 14.

Unique Pricing Factor (UPF): Attribute of buyer profiles that enables sellers to uniquely differentiate prices between buyers and have general purchasing characteristics of particular buyers reflected appropriately in price quotations. The UPF is a number, typically a percentage or a currency amount, entered into the respective user profile by, for example, a relationship manager and used by the price configurator in price conversions calculations associated with the respective buyer. Through effective use of the UPF, sellers can disseminate price information directly and confidentially to targeted buyers and more accurately ensure that product prices are reflective of the true cost of executing the transaction.

Taxonomy: Hierarchical organization of products by categories and subcategories. The system-wide taxonomy forces product managers to create product for their respective companies under a predetermined hierarchy of standard product groups. This allows buyers to compare product offers from a variety of sellers on a single viewing, for example, on a single web page of the Internet or other global computer network.

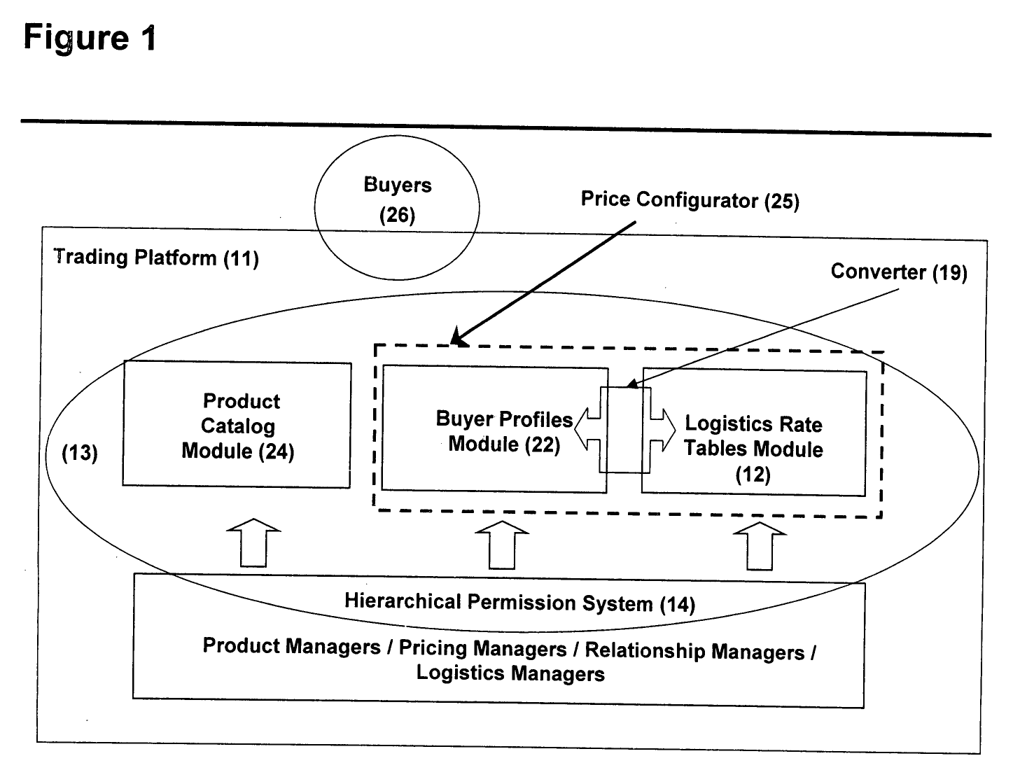

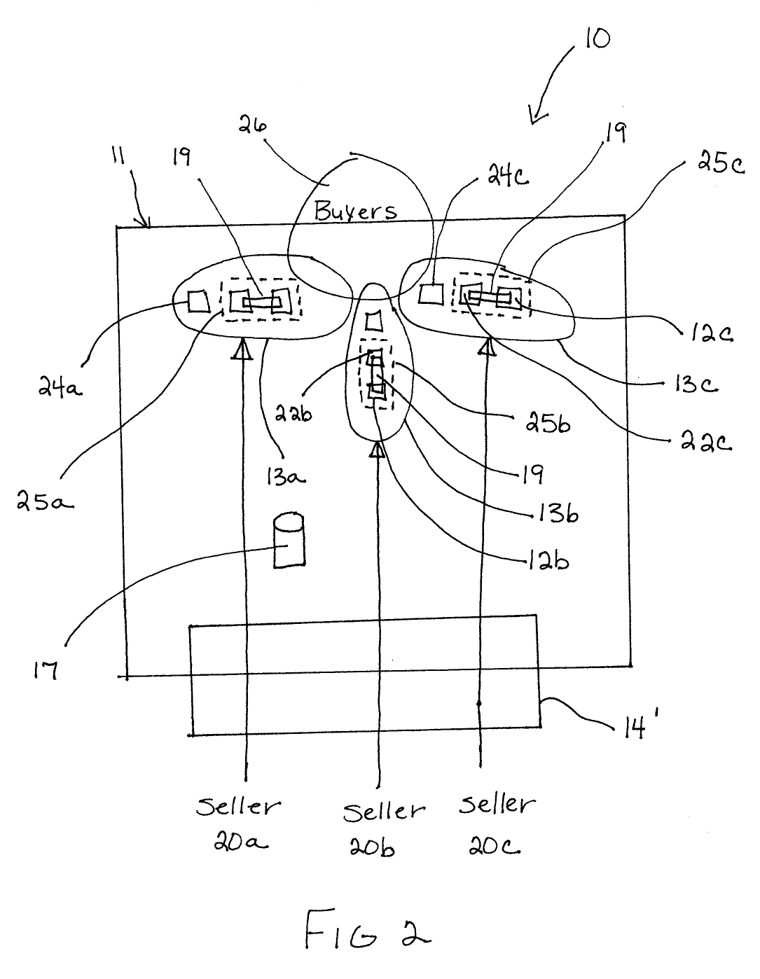

Refer now in more detail to the drawings in which like numerals refer to like parts throughout the several views. FIG. 1 illustrates a partner relationship management system (10) of the present invention, according to one embodiment, and is seen as comprising a trading platform 11, for example a computer and software based server, on which is maintained at least one seller environment 13. The seller environment 13 includes a product catalog module 24 and a price configurator 25, which price configurator operationally encompasses a logistics rate tables module 12 and a buyer profiles module 22, all proprietary to the respective seller. The price configurator 25 also includes a converter 19 which is, in preferred embodiments, a program function provided by the platform 11 and acts upon the proprietary data of the seller environment 13. The trading platform 11 includes or has accessible to it additional databases 17 which supplement the proprietary data of the seller environment 13, such as additional logistics information, master origin lists master destination list, taxonomy, and other data. In alternate embodiments of the PRMS of the present invention, the trading platform 11 supports a plurality of seller environments 13 (e.g., 13a, 13b, 13c), as is schematically represented by FIG. 2. The separation of these seller environments 13a-13c might be, alternately, physical (as on separate memory media) or operational (as by requiring separate commands or access privileges) or otherwise maintained.

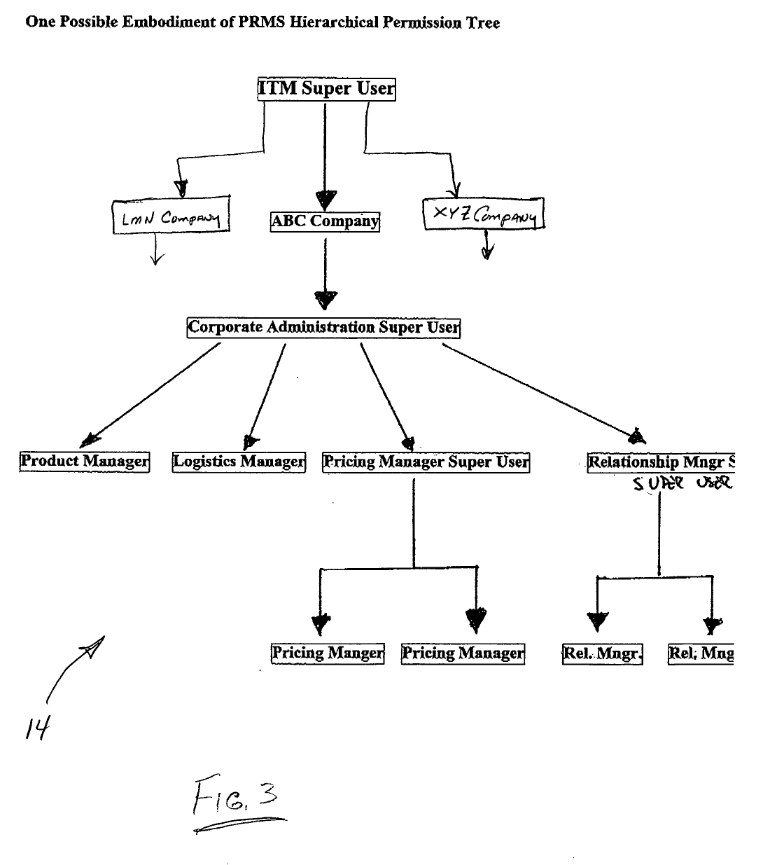

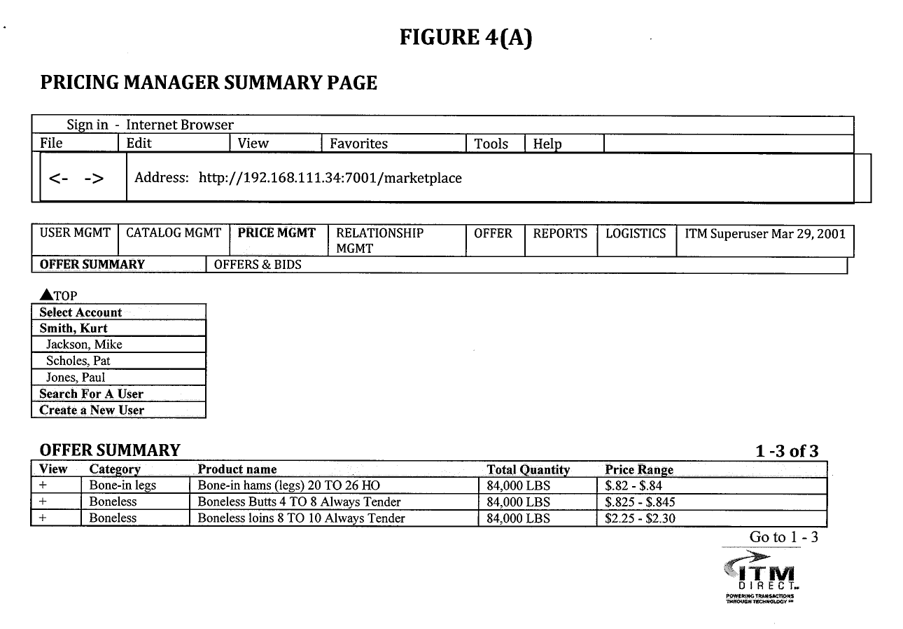

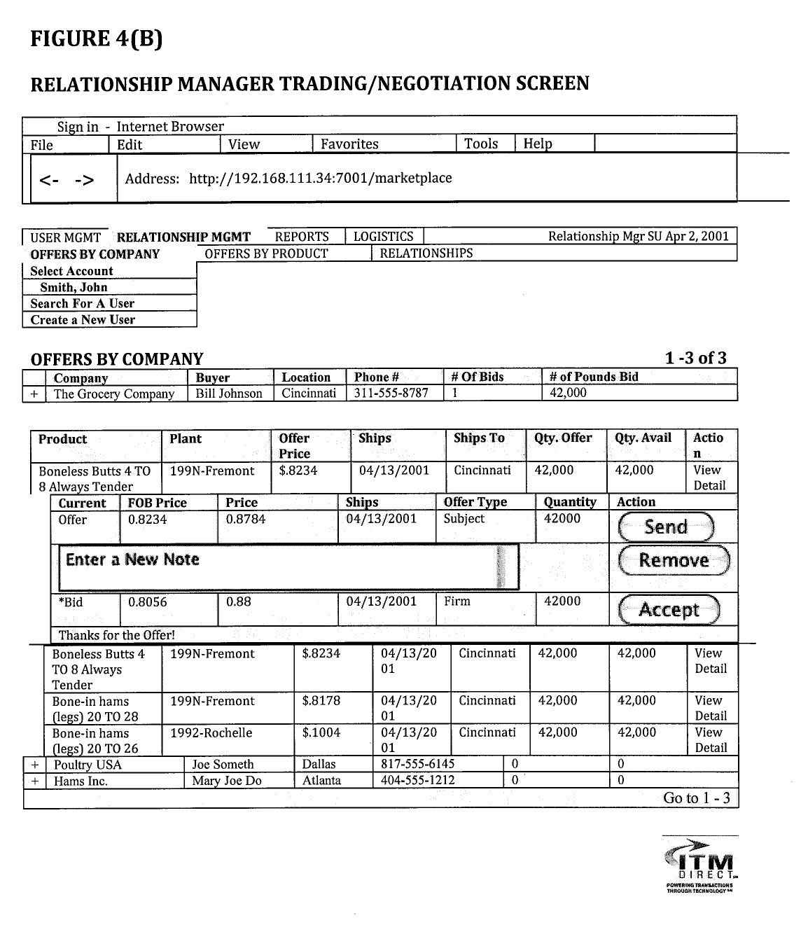

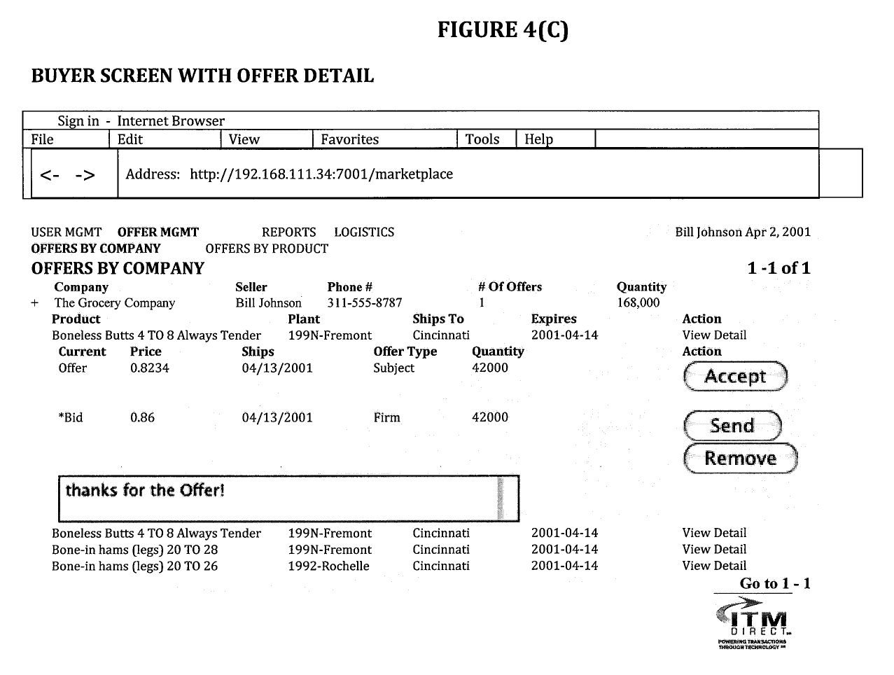

As seen in the exemplary embodiment of FIG. 1, a hierarchical permission system 14 is used to structure and focus the seller's functional users by limiting certain functional users to access to only certain of the modules/data of the seller environment 13, and, thus, to only certain features of the PRMS 10. In certain alternate embodiments of the present invention, a permission system is acceptably not included. As represented by FIG. 2, exemplary embodiments of the PRMS 10 which include a plurality of seller environments 13a, 13b, 13c, may include a hierarchical permission system 14′ to (i) provide confidentiality for and separation between separate seller environments and (ii) to provide structured and focused access to the functional users within each seller environment. A representation of a permission tree of one possible embodiment of a PRMS hierarchical permission system 14 is depicted in FIG. 3. As a result of a permission system 14, those embodiments of the present invention which utilize such a permission system include a plurality of distinctly presented user screens (or interfaces) which present to the each respective functional user only the data and interactive functions associated with that users permitted access. By way of example only, refer to FIGS. 4A-4C for examples of possible personalized interfaces for a relationship manager, a pricing manager, and a buyer, respectively.

In accordance with one exemplary embodiment, the logistics rate table module (12) comprises at least freight costs which are determined based on applicable insurance cost, warehousing cost, and transportation cost. The data of the logistics rate table module can be either provided by the respective seller(s) 20 or by the PRMS 10 as a service to the sellers. Buyer profiles (22) are populated with data about buyers and inputted by the respective sellers (20). Each seller (20) supplies information about his buyers/customers to the trading platform (10), and this information is used as one basis for calculating an offer price to the targeted party during price configuration in the offer management process. Sellers (20) also provide information to the trading platform (10) about all products that the seller will offer to all buyers, and this information populates the product catalog module (24) of the respective seller environment (13). A subset of the seller's products are entered in each buyer profile reflecting seller's products that are commonly offered to each respective buyer. In common embodiments of the present invention, standard interfaces presenting fixed data entry formats and standard data fields are presented by the system to assure that at least the minimum, necessary data is entered in the respective databases.

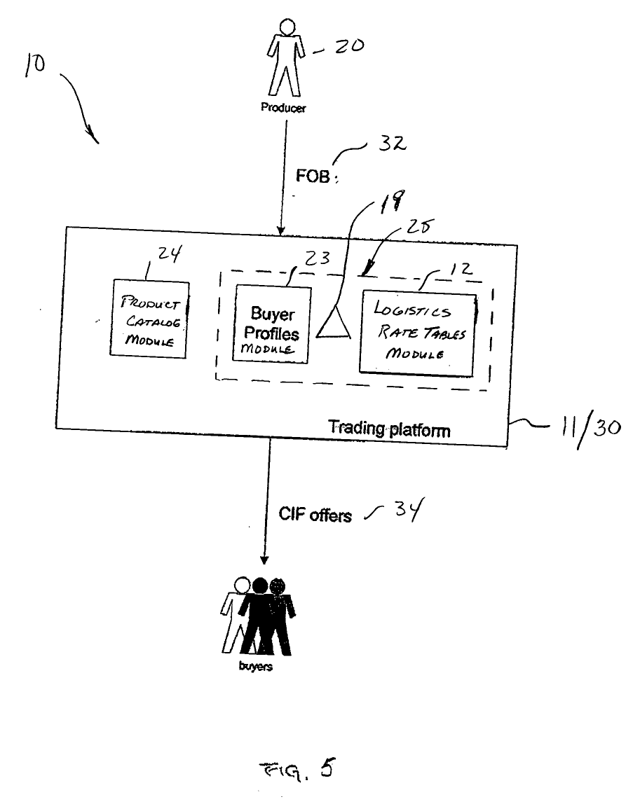

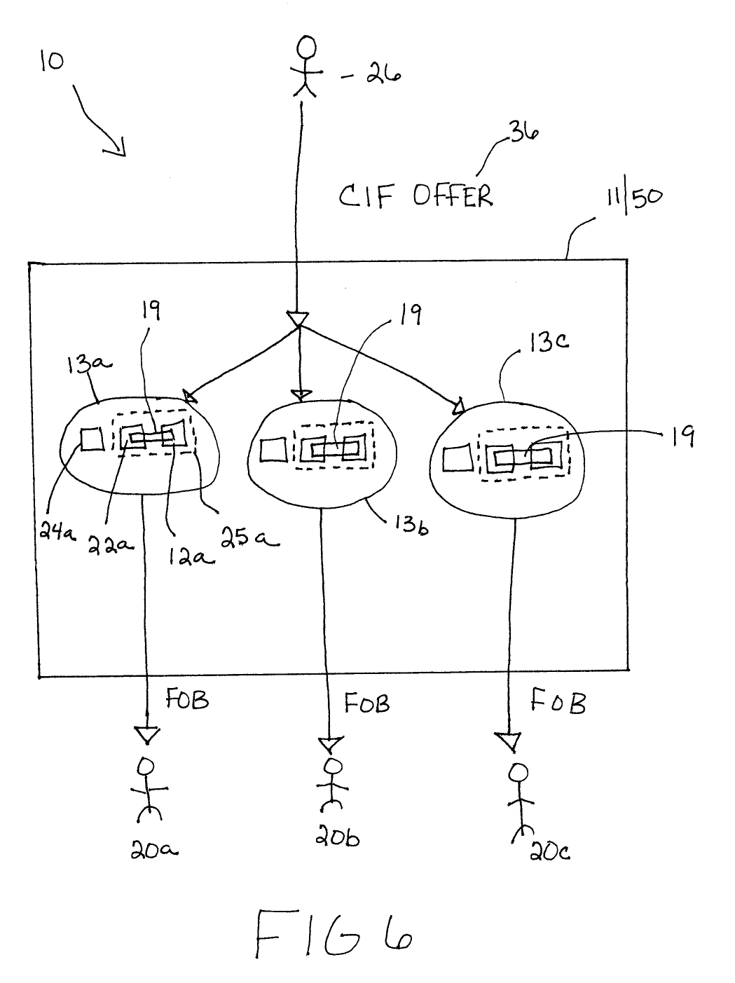

In one exemplary embodiment, the trading platform (10) offers three transaction formats or transaction models, including the seller initiated private trading channel, a buyer initiated reverse auction, and an open auction. FIG. 5 illustrates the predominant model—the seller initiated private trading channel. The reverse auction model is discussed with reference to FIG. 6. The open auction model (not shown) is useful for the sale of unique items.

The seller initiated private trading channel (30) (see FIG. 5) preserves the close relationships that have been developed between sellers (20) and, for instance, their international buyers (26). In accordance with this aspect of the invention, a seller (20) will enter origin prices, e.g., FOB prices, associated with selected product (see step 32) he desires to sell. The price configurator 25, drawing on data (including UPF) from the respective buyer's profiles 22 and from the logistics rate table module 12 will automatically determine customized delivered price offers (at step 34) for each approved customer. The delivered offer prices will be confidentially provided to each buyer (26). Buyers (26) will have the ability to compare competing offers from their sellers in a consolidated screen. Buyers (26) may either indicate approval of the offer prices or make counter-bids. This method provides a seller (20) the ability to market and sell product in an intuitive manner, while providing the ease of automation and greatly expanding market reach.

In the reverse auction model, as illustrated in FIG. 6, if a buyer (26) wants to invite current suppliers/sellers (20) to competitively bid on a particular order, the buyer (26) may initiate a “request for quotation” (at step 36). The buyer (26) will specify parameters such as commodity, grade, cut, desired delivered price, location, quantity, and delivery timeframe. This information will be transmitted to any supplier/seller (20) the buyer (26) chooses, as long as that seller (20) has previously profiled the buyer (26) as a customer. Using the international pricing configurator 25, with related UPF and appropriate logistics data, the trading platform 11, functioning as the reverse auction trading platform (50) will generate and also transmit to each seller 20 (20a-20c) a customized origin price offer, for example, FOB price. Each seller (20) will have the option to indicate approval of the proposed order or make a counter-offer.

On occasion, a seller (20) may wish to offer special items for sale on the open market in the open auction model. In this model the seller (20) would specify parameters such as commodity, grade, cut, origin price, quantity, and delivery timeframe. This information would be transmitted to all buyers (26) profiled by the respective seller, and each buyer (26) will then place an order or make a counteroffer.

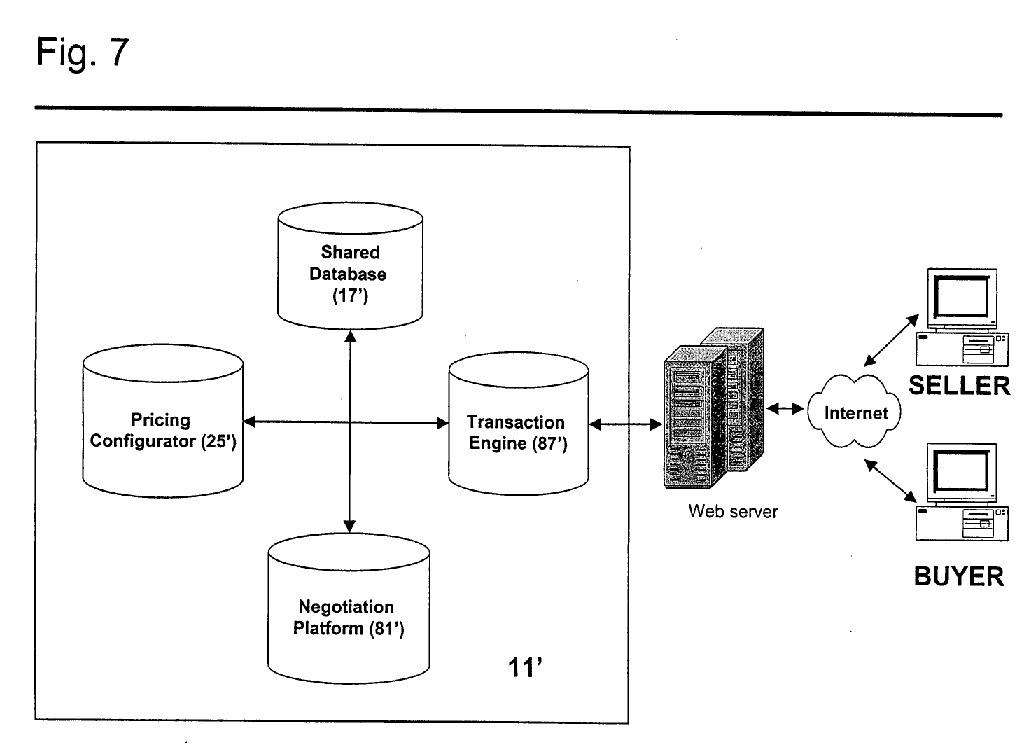

FIG. 7 shows the architecture of one embodiment of the PRMS 11′, and its components. A trading platform 11′ includes at least a negotiation platform (81), a shared database(s) 17′, a pricing configurator (25′), and a transaction engine (87). A trading platform (11′) resides on a server connected to, for example, the Internet 89. According to one embodiment, all software and databases associated with the platform 11′, including but not limited to the seller environments 13, reside on a single database; and, in alternate embodiments, the platform 11′ components are distributed, yet accessible from a single server. The trading platform 11′ is accessible via the Internet by remote users, i.e., sellers and buyers, through the use of a network client, including, but not limited to, a web enabled device, such as, for example, and preferably, a browser application. A negotiation platform (81) holds offer and counteroffer information during the duration of an offer negotiation. The offer and counteroffer information (e.g. negotiation history for both completed and failed negotiations) or alternately at least the concluded transaction data (such as date, reference numbers, party names, agreed upon price, product description, quantity, final value, origin, destination, and agreed upon shipping date) are archived in the negotiation platform 81. A shared database(s) 17′ has information on ancillary services, including but not limited to insurance, transportation, and warehousing, as well as other common data available to all seller environments such as but not limited to master location lists and taxonomy. A pricing configurator (25) utilizes buyer profile and logistics rate table information to convert an origin offer to a delivered price (and vice-versa if buyer initiates). Transaction engine (87) which manages payment tracking, payables, receivables and credit information, tracks a sales transaction after buyers and sellers enter into an agreement. According to exemplary embodiments, all seller environments 13 utilize these same components, but are confidentially segmented within the components.

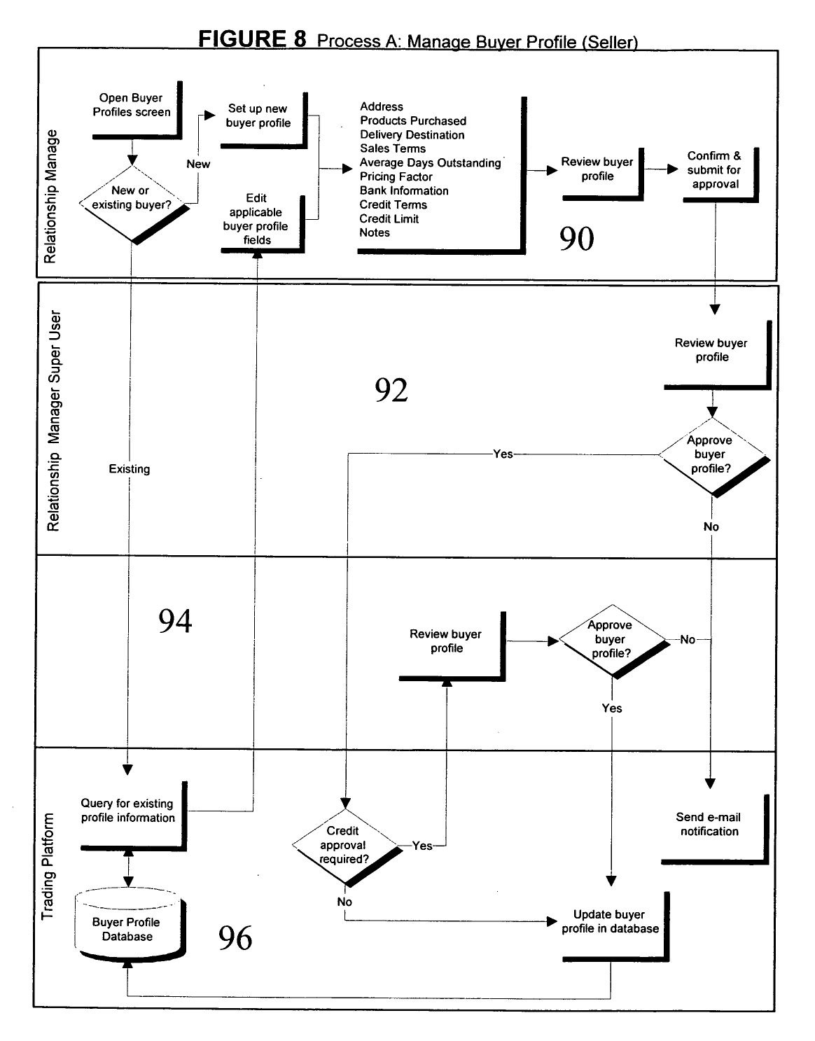

FIG. 8 is a flow chart for an account management process according to one embodiment of the present invention. A buyer profile account is opened (Box 90) by, for example, a relationship manager. The profile includes one or more of, but is not limited to, the following: Address; Products Purchased; Delivery Destination; Sales Terms; Average Days Outstanding; Pricing Factor; Bank Information; Credit Terms; Credit Limit; Notes. The proposed account may need to be approved by a relationship manager superuser (Box 92) (and perhaps by another level of review (Box 94)) at the same corporation). The account information is stored in the trading platform 11 (Box 96). A buyer is granted access to the trading platform, as previously discussed. A buyer's privilege to access the system is based on his relationships with his sellers.

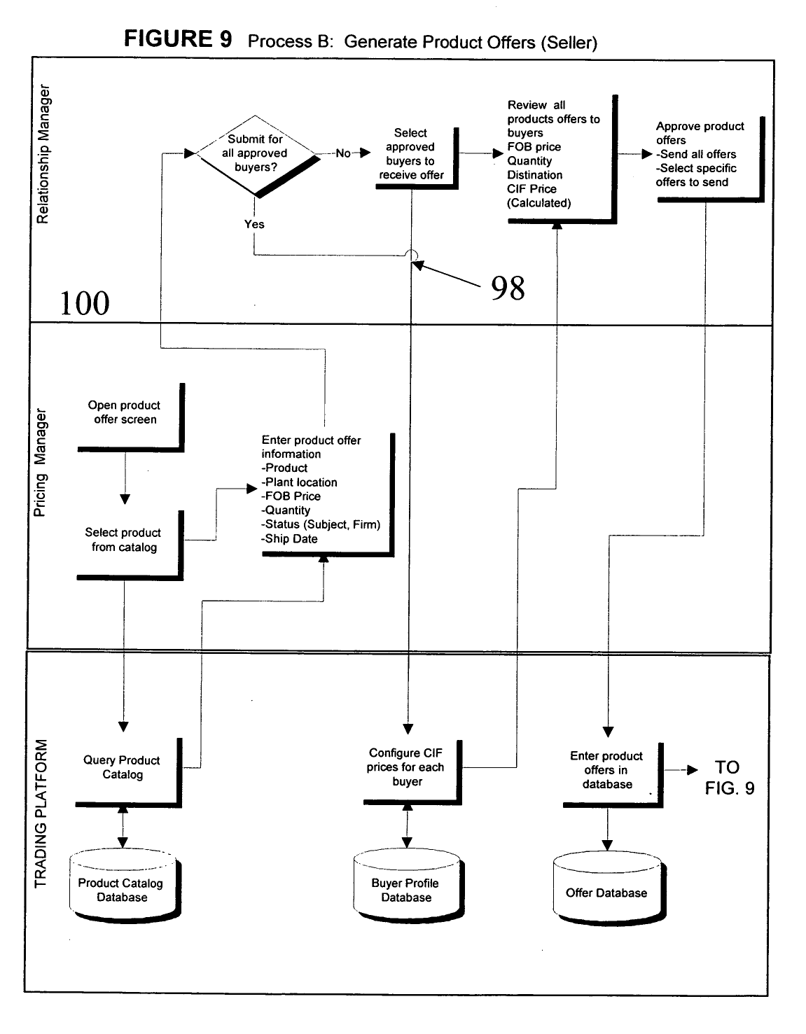

FIG. 9 is a flow chart for a product offering process according to one embodiment of the present invention. The pricing manager, for example, specifies what product is available for sale and at what price, and this information is stored in the trading platform 12 and also forwarded to the relationship manager. The relationship manager, for example, determines to which buyers to submit this offer (Box 100), and the trading platform converts the origin offer price set by the pricing manager into a delivered price. The conversion of an origin offer price to a delivered price is performed by a pricing configurator. The pricing configurator performs the calculation based on the factors that include some or all of, but are not limited to:

1—loading charges

2—documentation/inspection charges

3—additional cold storage/handling charges

4—inland trucking charges

5—inland rail charges

6—crossdock/transload charges

7—dray charges

8—ocean charges

9—cargo insurance

10—credit insurance

11—forwarding fees

12—courier charges

13—interest cost

14—banking fees

15—Pricing factor

By way of an example, items 1-14 above are drawn from the logistics rate tables module 12 of the seller's environment 13 and item 15 is drawn from the respective buyer profile of the buyer profile module 22 of the seller's environment.

The relationship manager has the option of verifying all of the information including the delivered price before finally approving the offer to be submitted to selected buyers. Alternatively, offers can flow automatically through the platform 11 from pricing managers to customers with no interim step, if the seller so chooses (see branch 98).

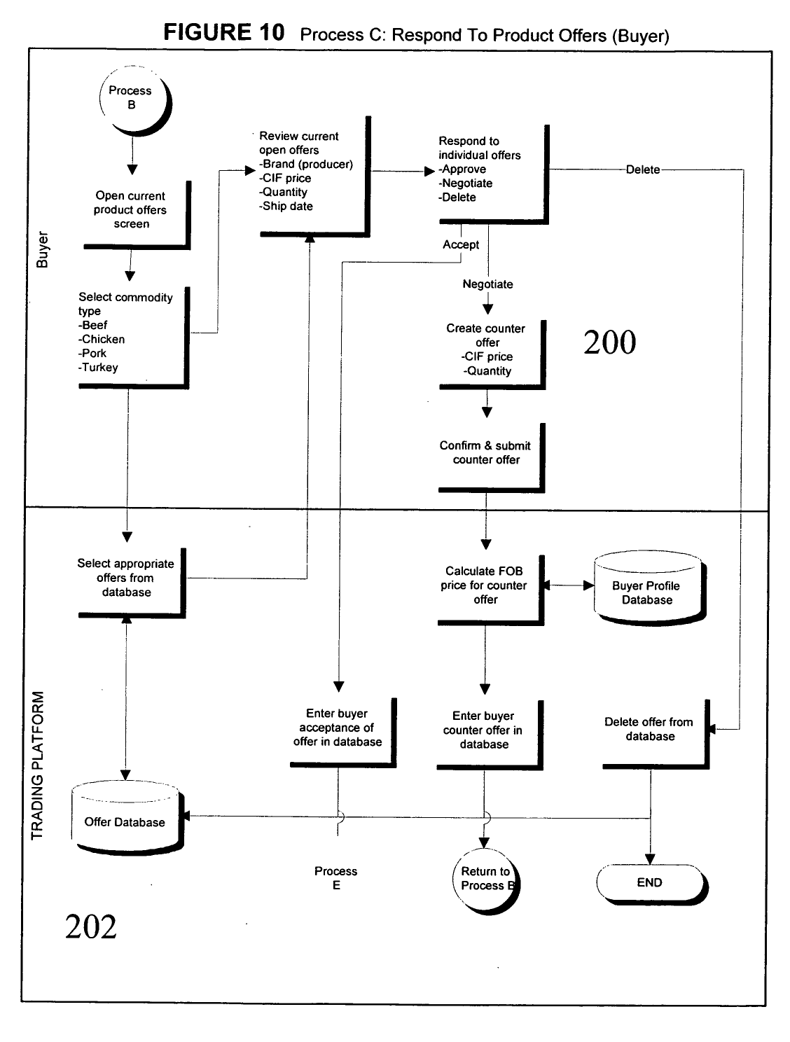

FIG. 10 is a process for a buyer responding to an offer, according to one embodiment of the present invention. A buyer may get offers from more than one seller and for more than one product (Box 200). The buyer selects a type of product to review offers in that product type. He can indicate approval of the offer as it is offered, or he can negotiate the offer by making a counteroffer (Box 202). If he makes a counteroffer, his terms in delivered pricing will be converted by the trading platform to origin offer pricing, such as FOB pricing, and then sent back to the seller.

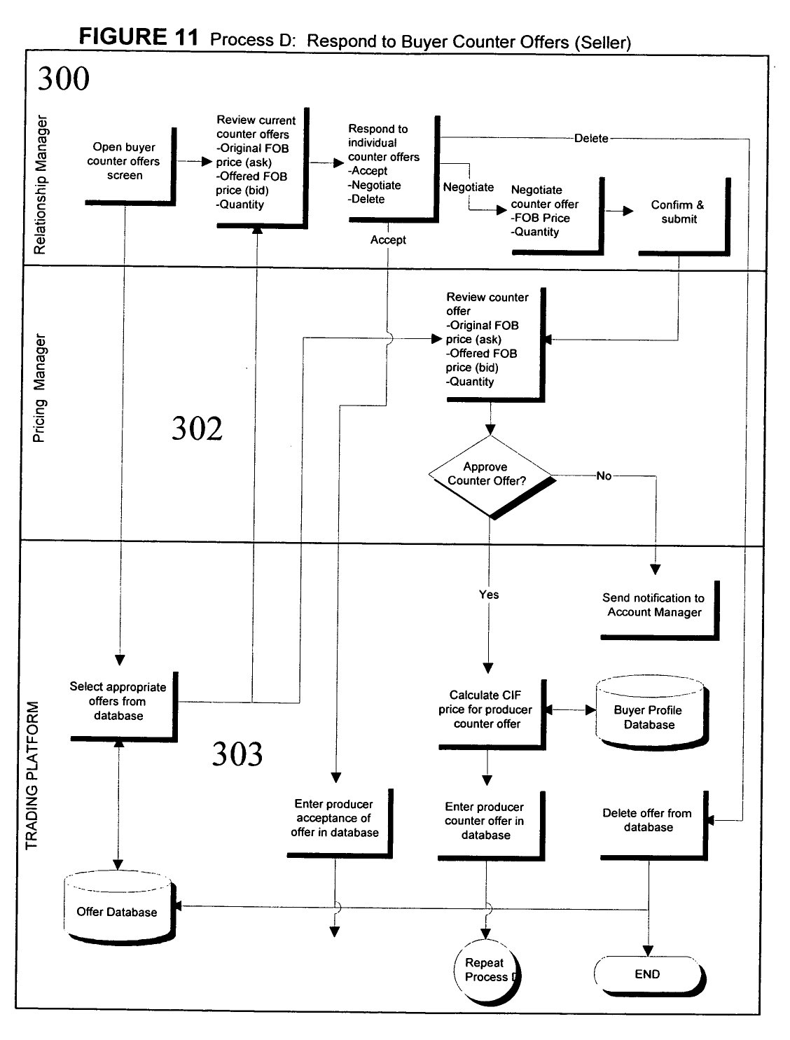

FIG. 11 is a process for a seller responding to a counteroffer. The relationship manager receives the counteroffer and analyzes it (Box 300). He can indicate approval of it as is, or he can further negotiate the terms. If he further negotiates the offer, the pricing manager has the opportunity to approve the counteroffer (Box 302) before it is submitted to the buyer (Box 303). The PRMS 11 converts the new counteroffer origin price to a delivered price by reference to the buyer profile 22, using the configurator 25.

### EXAMPLE

### One Example of a PRMS Configuration Process

In accordance with at least one embodiment of the present invention, to ensure effective use of the PRMS by functional users, selling organizations need to enter detailed information in the following modules:

### Configuration of Logistics Rate Tables:

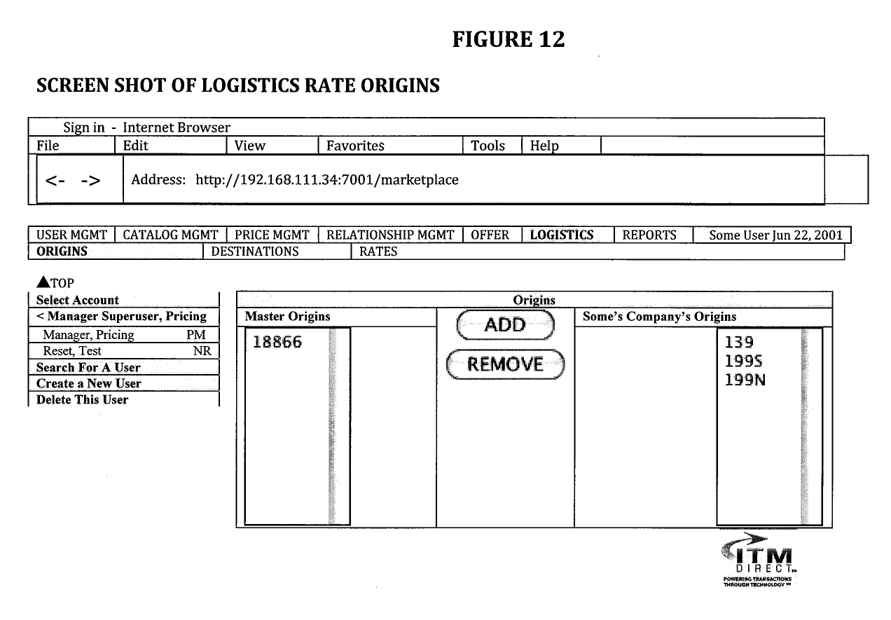

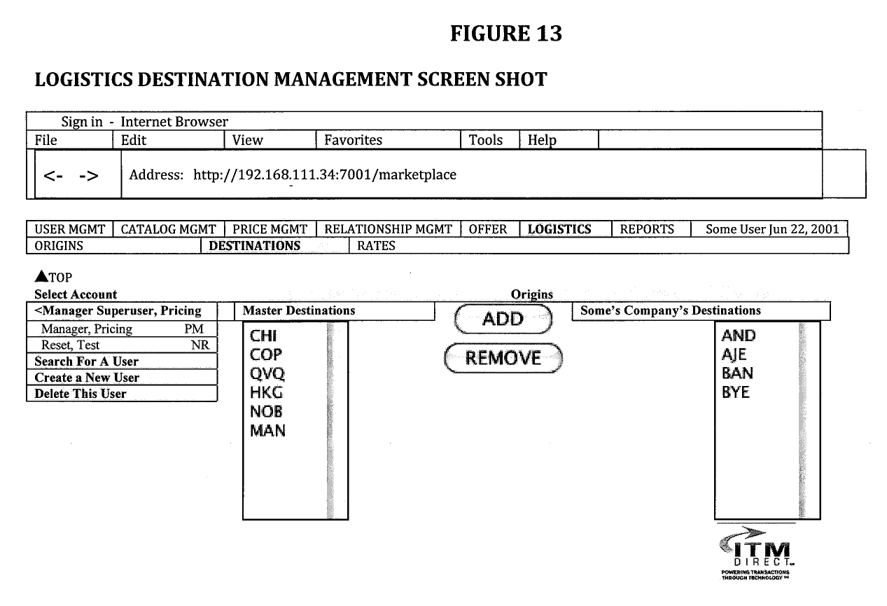

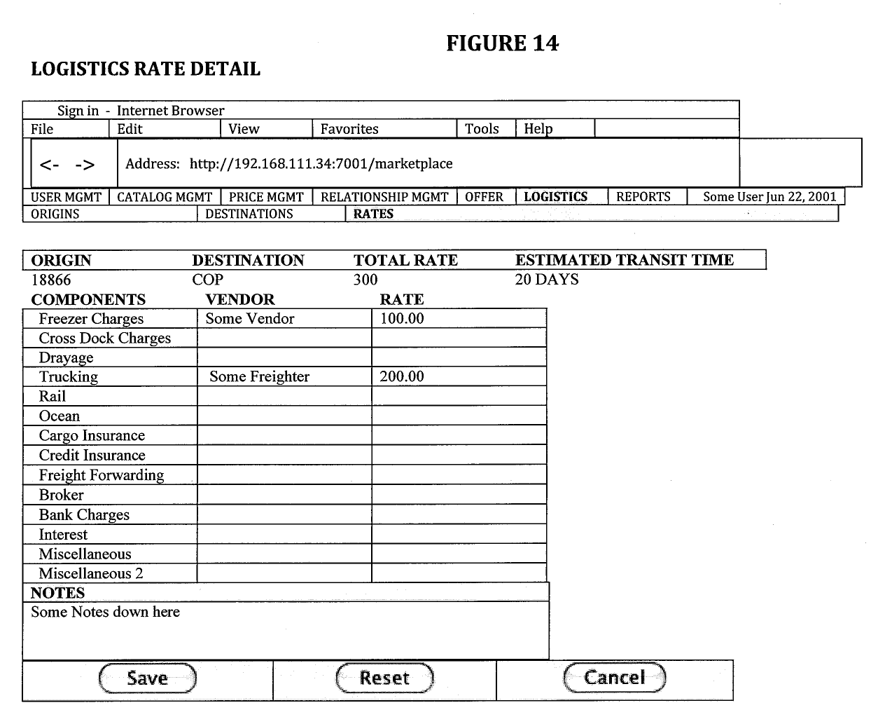

1. Logistics Manager selects his company's applicable points of origin (i.e., the physical locations where all of the companies products are produced and/or stored) from a master list of origins (from, for example, common database 17) maintained by the platform 11 administrator (e.g. platform superuser). (Refer, for example, to FIG. 12).
2. Logistics Manager selects his company's applicable points of delivery (the physical locations where the company's products are to be delivered) from a master list of destinations (from, for example, common database 17) maintained by the platform 11 administrator (e.g. platform superuser). (Refer, for example, to FIG. 13).
3. Logistics Manager enters freight values (aggregate costs) for the origin-destination relationships applicable to his organization. (Refer, for example, to FIG. 14).

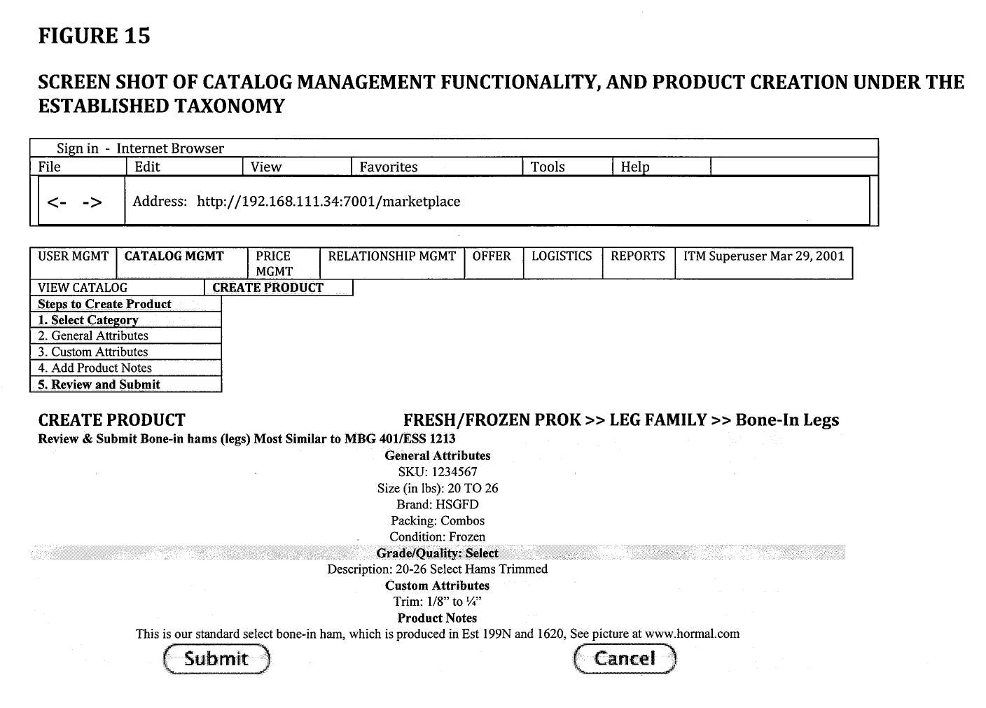

### Configuration of Product Catalog Module 24 (Refer, for Example to FIG. 15):

1. Using the system's taxonomy (for example, as maintained in common database 17), product manager “creates” product under the appropriate taxonomy categories, entering such information as product description, seller-specific product attributes, SKU numbers, and product notes.
2. Using the above data, PRMS creates a company-specific sub-catalog within the system's product database.

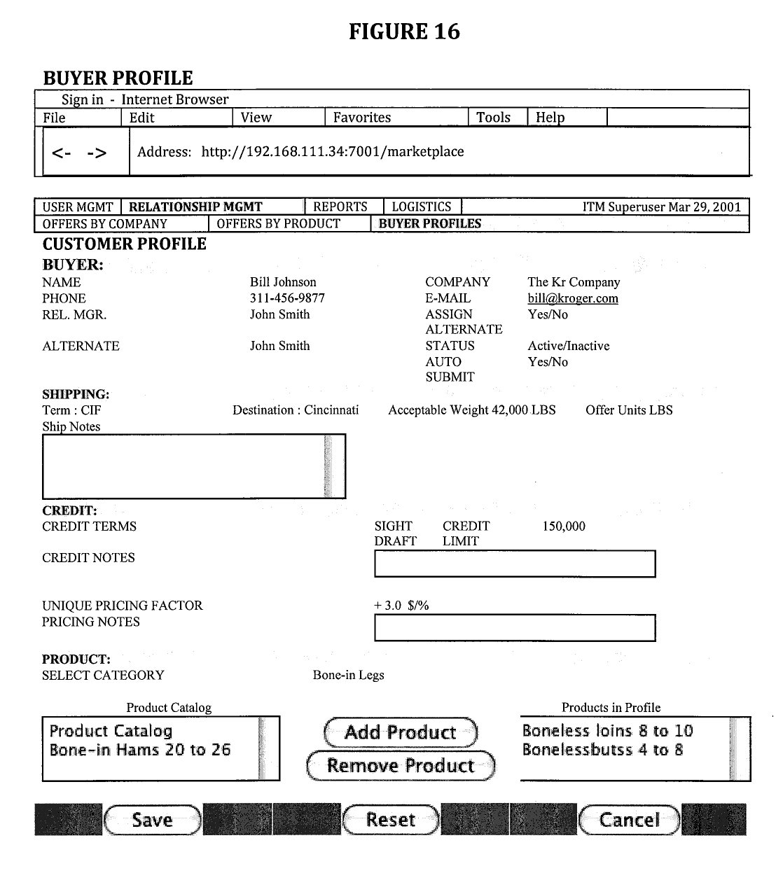

### Configuration of Buyer Profiles Module 22 (Refer, for Example, to FIG. 16):

1. In the Buyer Profile Module 22, Relationship Managers enter basic corporate information regarding the buyers they are directly responsible for selling (i.e., contact information, bank information, destination (s) of product delivery, shipping terms, credit terms, etc.),
2. Relationship Managers enter a UPF for each buyer, either in currency per unit or on a percentage basis.
3. For price calculation purposes, Relationship Managers enter an Acceptable Weight Value for each buyer (i.e., the typical weights that a particular buyer is accustomed to receiving).
4. Relationship Managers select product from the catalog previously created by the Product Manager and grant total or limited product access to the buyer.

### One Example of a PRMS Transaction

To better understand at least some of the aspects of the present invention, the following example embodiment is provided, it being understood that while certain features and values are utilized in the example, the invention is not limited to the utilized values or features nor to the related functionality.
1. Using his personalized screen within PRMS, Pricing Manager for ABC Company enters a price of 0.50/lb on Product X, which has an origin location of Chicago. (i.e., $0.50/lb FOB Chicago)
2. The system performs a search of all ABC Company buyer profiles (numbering 500) in the Buyer Profile Module 22 and determines which buyers have been profiled to receive offers on Product X. PRMS determines that 50 buyers meet the search criteria. One such buyer is ZZZ Imports in Hong Kong.
3. From the Buyer Profiles, PRMS records the product delivery locations of the 50 selected buyers (including three separate delivery locations for one of the buyers), their Acceptable Weight Values and Unique Pricing Factors. ZZZ Imports Acceptable Weight Value is 54000 lbs and his UPF is +$0.01/lb.
4. PRMS searches within the Logistics Rate Table Module for matches between Chicago (product origin) and the destinations of the 50 buyers. PRMS records the freight values for all 52 origin-destination relationships (which includes the 3 origin-destination relationships for the one buyer). ABC Company's aggregated freight value from Chicago to Hong Kong is $5000.
5. PRMS calculates a distinct and unique delivered price on Product X to each of ABC Company's 50 buyers (3 delivered prices for the multi-destination buyer) based on the origin offer price at origin (0.50/lb FOB Chicago), the Acceptable Weight Value, the Aggregate Freight Value, and the UPF. ABC Company's calculated price to ZZZ Imports is 0.6025/lb, CIF Hong Kong.
6. PRMS looks to respective the buyer profile to discover the desired unit of measure for that buyer (e.g. pounds, kilograms, metric tons) and makes appropriate unit of measure conversion as necessary. Desired unit of measure for ABC Company is pounds—no unit conversion.
7. The origin price, delivered price, and all offer details are presented to the Relationship Managers of ABC Company responsible for managing the 50 accounts.
8. Using his/her personalized screen with PRMS, each Relationship Manager has the option of editing the price of each offer(s) to his/her responsible accounts, deleting the offer(s), or submitting the offer(s) to the buyers. The Relationship Manager increases ZZZ Imports' price to 0.6125/lb CIF Hong Kong.
9. PRMS submits unique offers to each of the 50 buyers by posting to a site location accessible by respective buyer.
10. After comparing prices among other sellers on the system, ZZZ Imports submits, through the PRMS system, a bid of 0.6050/lb CIF Hong Kong to the Relationship Manager of ABC Company.
11. PRMS reverse calculates the bid price and submits the CIF bid of ZZZ Imports and its FOB equivalent to the Relationship Manager, and submits an FOB Chicago price of 0.5025/lb to the initial pricing manager that started the process.
12. The Relationship Manager confirms the order with ZZZ Imports at 0.6050/lb CIF Hong Kong.
13. PRMS informs the pricing manager that a completed transaction took place at a price equivalent of 0.5025/lb FOB Chicago.

Although the invention has been particularly shown and described with reference to a preferred embodiment (and selected examples) thereof, it will be understood by those skilled in the art that various changes in form and detail may be made without departing from the spirit and scope of the present invention.

Additionally, corresponding structures, materials, acts and equivalents of any means plus function elements in any claims below are intended to include any structure, material, or acts for performing the functions in combination with other claimed elements as specifically claimed.

1. A method of facilitating trade, comprising the steps of:
receiving an input price from a network client as input to a computer program at a network server;
accessing via the computer program a plurality of preconfigured buyer profiles, each profile of the plurality of buyer profiles including at least the identification of a buyer, a delivery destination and a pricing factor associated with the identified buyer;
accessing via the computer program a logistics database which includes at least costing information associated with shipping to delivery destinations;
configuring via the computer program a plurality of output prices, each output price being associated with one buyer profile of the plurality of buyer profiles, and each output price being a modification of the input price and reflecting at least (i) a cost of shipping to the delivery destination of the respective associated buyer profile and (ii) a price adjustment affected by the pricing factor of the respective associated buyer profile; and
confidentially distributing the plurality of output prices, including the step of distributing to the identified buyer associated with each buyer profile the output price associated with the respective associated buyer profile.

2-24. (canceled)
